(19) United States
(12) Patent Application Publication
(10) Pub. No.: US 2004/0112902 A1
(43) Pub. Date: Jun. 17, 2004

(54) Paint tray liner system and method

(76) Inventor: Mark Campbell, Draper, UT (US)

Correspondence Address: Steve M. Perry, THORPE NORTH & WESTERN, L.L.P., P.O. Box 1219, Sandy, UT, 84091-1219, US

(21) Appl. No.: 10/322,248

(22) Filed: Dec. 17, 2002

(51) Int. Cl. B05C 21/00

(52) U.S. Cl. 220/570

(57) ABSTRACT

A paint tray liner system and method uses a paint tray and a paint tray liner. The paint tray liner is a sheet of flexible material with an adhesive layer disposed on one side. The adhesive removably adheres the flexible sheet to the inside surface of the paint tray, so as to form a barrier between liquid paint in the tray and the inside surface of the tray. After use, the liner is peeled away from the paint tray and discarded with any paint or paint residue that remains, substantially reducing the need to clean the paint tray.

### BACKGROUND OF THE INVENTION

1. Field of the Invention

The present invention relates generally to painting equipment.

2. Related Art

Paint trays are well-known, commonly used items. They are helpful when using paint rollers or pads, for example, in both interior and exterior painting of buildings. The paint tray allows a user to apply paint evenly to the entire surface of a paint roller, which enables the user to then apply the paint to a wall, ceiling, or anything else with the roller.

A typical paint tray comprises a shallow, rectangular pan, usually of metal or rigid plastic, and typically includes a sloping ramp portion. The pan is configured to receive and contain a volume of wet paint. The sloping ramp provides a surface for contacting a roller to enable a user to roll the roller in the paint, and to daub off excess paint. Both the pan area and the ramp area frequently include ridges, bumps, and other irregularities in their shape to both strengthen the device, and provide contact surfaces for encouraging rolling of a paint roller. The underside of the paint tray may include feet for supporting it on a flat surface, such as a table or floor, or may include various kinds of hooking or fastening mechanisms for allowing the paint tray to be connected to a ladder, a paint bucket, or some other supporting structure.

Users of paint trays are well aware of the constant need of cleaning. After use, a paint tray must be adequately cleaned to prepare it for its next use. Wet paint must be cleaned out, and dry paint that could flake off and contaminate subsequent painting operations must be removed. This process is complicated by the ridges and other surface irregularities of the paint tray. Additionally, paint trays of metal are likely to have folded metal edges that provide many small gaps and seams into which paint is likely to collect.

Not only is the cleaning of a paint tray tedious and time-consuming, it can also present an environmental hazard. When wet paint and/or paint flakes are washed off of a paint tray, this contaminates the water that washes it away. If this water enters a storm drainage system, it is likely to eventually discharge directly into a river or stream, thus contaminating surface waters with a collection of chemicals and pigments. This is especially problematic with oil-based paints. Alternatively, if the cleaning water is discharged into a municipal sewer network, this imposes a substantial burden on the wastewater treatment system. Again, this problem is particularly severe where oil-based paints are involved.

In recent years, paint tray liners have come into widespread use. Paint tray liners generally comprise a rigid or semi-rigid plastic pan with a shape that is complementary to the inside of a paint tray. The user inserts the liner into the inside of the paint tray, and pours the paint into the liner. When finished, the user can simply remove the liner from the paint tray and discard it. In this manner, paint waste hopefully ends up in a landfill in an ultimately solid state, rather than as a liquid in the water supply, and because the wet paint did not actually contact the paint tray, there is no need to clean the paint tray.

Unfortunately, the increasing popularity of paint tray liners has not solved all of the problems. Typical plastic paint tray liners are somewhat bulky injection-molded items made of hard plastic. Consequently, they are relatively expensive. Given their expense, users tend to treat them like the paint tray itself—washing them out for reuse. Obviously, this does not alleviate the environmental concerns, and also consumes the time and effort of the user. Moreover, perhaps because of this phenomenon, the trend in the paint tray industry has been to produce disposable paint trays. The disposable paint trays are made of a heavier plastic for strength to allow a paint roller to be used without crushing them. Unfortunately, because of this increased strength, users are even more likely to wash and re-use them just as they would a more conventional paint tray. In this way, the disposable paint trays are not truly disposable. And, when they are discarded, they produce waste of substantial bulk.

### SUMMARY OF THE INVENTION

The invention advantageously provides a paint tray liner system, comprising a paint tray and a paint tray liner. The paint tray liner is a sheet of flexible material, such as a clear polymer, with an adhesive layer disposed on its back or bottom side. The adhesive is configured to removably adhere the sheet to the inside surface of the paint tray, so that paint or paint residue may be removed from the paint tray after use by removing the flexible sheet.

In accordance with a more detailed aspect of the present invention, a method is provided of using a paint tray, comprising the steps of: a) removably disposing a flexible, adhesive-backed liner against the inside surface of the paint tray; b) placing a volume of liquid paint into the paint tray atop the liner, the liner providing a barrier between the liquid paint and the inside surface of the paint tray; and c) removing the liner from the paint tray with remaining paint and paint residue after use of the paint tray, so as to reduce contact of liquid paint with the paint tray.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of one embodiment of a disposable paint tray liner in accordance with the present invention;

FIG. 2 is a perspective view of a paint tray having the liner of FIG. 1 installed therein;

FIG. 3 is a perspective view of an alternative embodiment of a disposable paint tray liner in accordance with the present invention;

FIG. 4 is a perspective view of an embodiment of a paint tray liner provided on a roll.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Viewing FIG. 1, the paint tray liner of the present invention comprises a flexible sheet 10 of polymer material with an adhesive layer 12 on its back or bottom side 14. The liner sheet may be clear or opaque. The sheets may be provided as individual sheets with a peel-away backing layer 16 disposed against the adhesive side. Alternatively, as depicted in FIG. 4, a linear series of individual liner sheets 110 may be disposed on a roll 112, the sheets being removable from the roll through tearing along a perforation line 114. Each sheet in the roll has its adhesive side 116 disposed inwardly, in the manner of a roll of adhesive tape.

The polymer material of the liner must be generally impervious to and non-reactive with paint materials, whether water-based or oil-based. One composition of polymer could be used for sheets specifically intended for use with only water-based paints, while another formulation could be provided for use with oil-based paints. Alternatively, a single composition could be provided for use with all types of paint.

The thickness of the liner sheet can vary within a wide range. However, a thickness is about 2 mils. Thinner sheets are harder to work with and are more susceptible to damage and tearing. However, if the sheet is too thick, it will be more difficult to use, as will become more apparent below.

The adhesive layer 12 can be any of a number of adhesives. The adhesive must be sufficient to attach the liner 10 to the paint tray 20 during use, but allow easy removal of the liner when use is completed. Adhesives of the rubber-cement variety could provide this sort of function. Other adhesives that provide removable adhesion of polymer materials are also well known. The adhesive may be sprayed onto the bottom side 14 of the sheet, or applied in other ways.

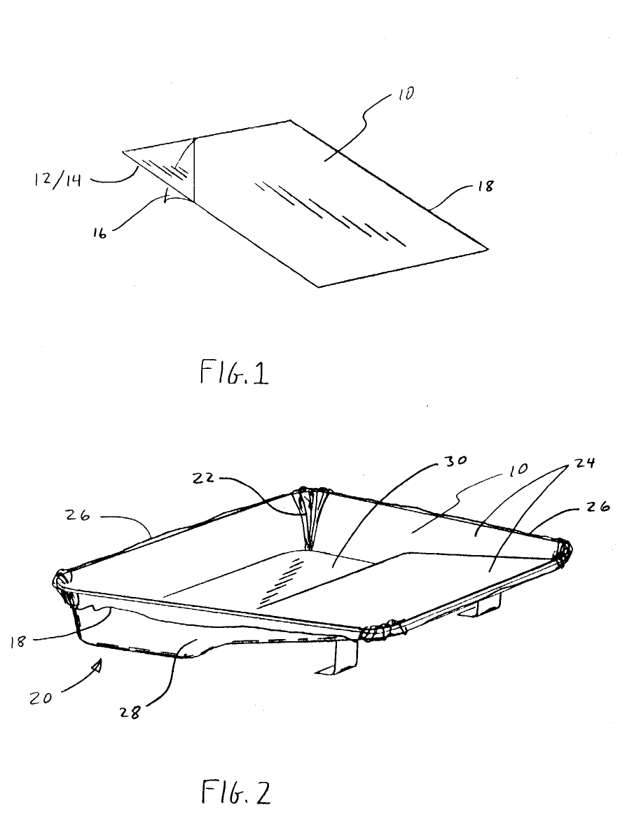

Viewing FIG. 2, to use the paint tray liner 10, a user exposes the adhesive side 14 of the sheet and aligns the sheet generally with a paint tray 20. Then the user presses the sheet into the tray, pushes it into the corners 22 and folds or creases the sheet as needed, causing the adhesive side of the sheet to stick to the inside surface 24 of the tray.

One technique for completely and neatly covering the inside of the paint tray is to press the center of the liner sheet onto the center of the paint tray, then work outward in all directions. This helps provide a smooth, wrinkle-free liner surface without bubbles and other disruptions. Because the liner sheet is thin and flexible, it naturally and easily conforms to the shape of the paint tray, exposing the ridges, bumps, and other shape irregularities of the tray. As noted above, if the liner is too thick, pressing it into the corners and onto irregular surfaces of the paint tray can be difficult. However, if it is too thin, simply handling the sheet can become difficult.

At the top edges 26 of the tray, the outer edges 18 of the liner sheet 10 can be neatly folded over the top edge of the tray to stick onto the outside 28 of the tray. This helps prevent liner edges from sticking up and getting in the way.

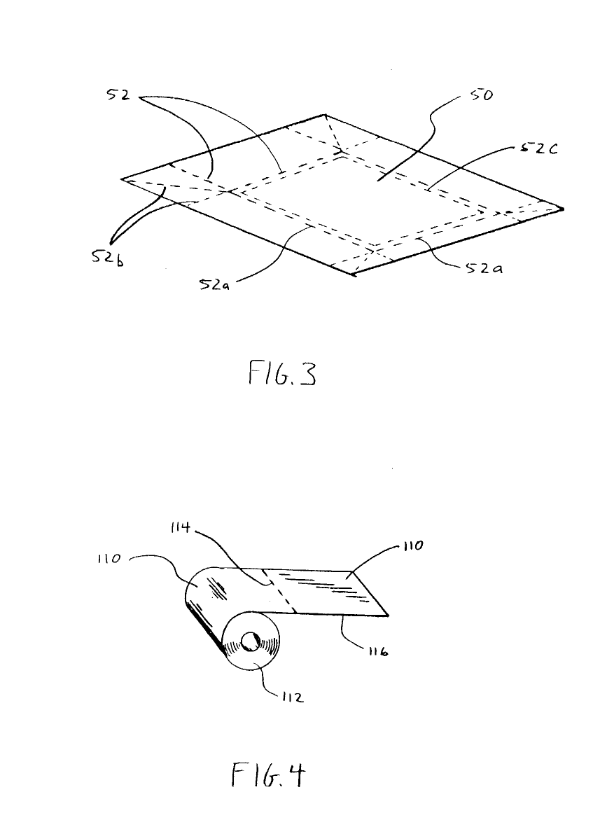

FIG. 3 illustrates an alternative embodiment of a paint tray liner 50 which includes score lines or fold lines 52 pressed into the sheet. The score lines assist the user in neatly folding the liner to conform to the shape of the paint tray. For example, score lines 52a can be provided to correspond to the top edge of the tray, making it easier to align the sheet with the tray and fold the liner over the top edge. Score lines 52b can correspond to an inside corner fold to assist the user in neatly inserting the sheet into the corners of the tray. Additionally, multiple parallel score lines 52c can be provided to correspond to different paint tray sizes. It will also be apparent that in addition to score lines or fold lines, other methods could be used to facilitate the folding of the paint tray liner in a desired manner.

Returning to FIG. 2, once the liner 10 is in place in the tray 20, when the user pours paint 30 into the tray, the liquid paint sits atop and contacts the liner, rather than the underlying paint tray. The liner thus provides a barrier between the liquid paint and the inside surface of the paint tray. When the user is finished, the liner is simply removed (i.e. peeled away) from the inside surface of the paint tray and discarded. The paint and paint residue are thus easily removed from the paint tray in one action, and discarded with the liner sheet. The user simply peels the liner out of the paint tray, wads it up, and throws it into a trash container. Before removing the liner, the user may wait until the paint that is in contact with the liner is substantially dry. Alternatively, if there is still some wet paint in the tray, the edges of the liner can be carefully drawn upward to contain the liquid within the liner—like a hammock—and the liner with the wet paint inside can be easily deposited into a waste container.

If the user takes adequate care when using and removing the liner 10, paint can be substantially or entirely prevented from contacting the paint tray 20, thus eliminating the need to clean the paint tray. Even if there is some spillage during use or removal of the liner, the time and effort required to clean the paint tray will be substantially reduced when compared to not using a paint tray liner.

Advantageously, using this invention, paint is substantially prevented from contacting the paint tray and waste receptacles. The discarded paint becomes solid waste, rather than liquid waste, which can foul rivers, streams, or increase the burden on wastewater treatment plants.

The waste produced is also a smaller volume of solid waste in comparison to other paint tray liners. Because the liner is a thin, lightweight sheet of plastic, it is significantly less expensive than many other so-called “disposable” paint tray liners. Indeed, the inventor believes this paint tray liner may cost just about 20% as much as other paint tray liners. This encourages users to actually dispose of the liners after use, rather than washing them as they would a conventional paint tray.

This paint tray liner presents many advantages over other paint tray liners. It creates less waste when disposed, and that waste is in a more manageable form. This invention reduces water usage. Also, because the liner is securely attached to the paint tray with adhesive during use, it does not slide around like some other paint tray liners. Furthermore, this paint tray liner is about one-fifth as expensive to produce as the rigid or semi-rigid plastic paint tray liners that are currently in use. Additionally, because the liner is a flat sheet of plastic that is pressed into a paint tray, it is possible to make one liner size fit all sizes and configurations of paint trays. Finally, the paint tray liner of the present invention requires less shelf space in stores and less storage space for the user.

An alternative embodiment of the invention can use paper that has been impregnated or covered with plastic. In addition, a waxy paper can be used with an adhesive backing. Using a paper derivative is not as easy as using a sheet that is entirely plastic because it will be more stiff. However, a paper/plastic mixture can be used for the sheet.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method of using a paint tray having an inside surface and configured to contain a volume of liquid paint, comprising the steps of:
a) removably disposing a flexible liner against the inside surface of the paint tray, the liner being held against the inside surface by an adhesive layer on the liner;
b) placing a volume of liquid paint into the paint tray atop the liner, the liner providing a barrier between the liquid paint and the inside surface of the paint tray; and
c) removing the liner from the paint tray after use of the paint tray, so as to reduce contact of the liquid paint with the paint tray.

2. A method according to claim 1, further comprising the step of discarding the liner as solid waste.

3. A method according to claim 1, further comprising the step of allowing paint in contact with the liner to substantially dry before removing the liner from the paint tray.

4. A method according to claim 1, wherein the step of removably disposing the liner against the inside surface of the paint tray further comprises pressing the sheet into inside corners of the paint tray, and creasing the sheet to conform the sheet to the shape of the corners.

5. A method according to claim 4, further comprising the step of folding an outer edge of the liner over a top edge of the paint tray, so as to adhere the outer edge of the liner sheet to an outside surface of the paint tray.

6. A method according to claim 1, wherein the step of removably disposing the liner against the inside surface of the paint tray further comprises pressing a center of the liner sheet onto a center of the paint tray, and pressing outward in all directions so as to provide a generally smooth, wrinkle-free liner surface corresponding to the shape of the inside surface of the paint tray.

7. A paint tray system, comprising:
a) a paint tray, having an inside surface and configured to contain a volume of liquid paint therein;
b) a flexible liner, comprising a sheet of thin, flexible material having a back side and a layer of adhesive disposed on the back side, the sheet being substantially impervious to paint, and configured to be removably adhered to the inside surface of the paint tray so as to create a barrier between the liquid paint and the inside surface of the paint tray, and thereby reduce contact of liquid paint with the paint tray during use.

8. A paint tray system in accordance with claim 7, wherein the flexible liner is from about 0.002″ thick to about 0.005″ thick.

9. A paint tray system in accordance with claim 7, wherein the flexible liner is substantially transparent.

10. A paint tray system in accordance with claim 7, wherein the flexible liner is substantially opaque.

11. A paint tray system in accordance with claim 7, further comprising a removable backing layer disposed against the adhesive layer, the backing layer being configured to be removed by a user before inserting the liner into the paint tray.

12. A paint tray system in accordance with claim 7, wherein the flexible sheet comprises one segment of an elongate series of flexible sheets removably connected together and disposed in a roll, the adhesive layer of the series of sheets being inwardly disposed in the roll.

13. A paint tray system in accordance with claim 7, further comprising fold lines disposed on the liner, the fold lines being configured to be aligned with features of the tray and to assist in folding the liner therealong.

14. A paint tray system in accordance with claim 13, wherein the fold lines correspond to locations of features of the paint tray selected from the group consisting of the top edge of the tray, and an inside corner of the tray.

15. A paint tray system in accordance with claim 14, further comprising multiple parallel fold lines corresponding to different paint tray sizes.

16. A paint tray liner, comprising:
a) a sheet of flexible material having a back side, and being substantially impervious to paint;
b) an adhesive layer disposed on the back side of the sheet, configured to removably adhere the sheet to an inside surface of a paint tray, and allow removal of the sheet following use of the paint tray, such that paint or paint residue may be removed from the paint tray by removing the flexible sheet.

17. A paint tray liner according to claim 16, wherein the sheet of flexible material is from about 0.002″ thick to 0.005″ thick.

18. A paint tray liner according to claim 16, further comprising a removable backing layer disposed against the adhesive layer, the backing layer being configured to be removed by a user before inserting the liner into the paint tray.

19. A paint tray liner according to claim 16, wherein the flexible sheet comprises one segment of an elongate series of flexible sheets removably connected together and disposed in a roll, the adhesive layer of the series of sheets being inwardly disposed in the roll.

20. A paint tray liner according to claim 16, further comprising fold lines disposed on the liner, the fold lines being configured to be aligned with features of the tray and to assist in folding the liner therealong.

21. A paint tray liner according to claim 20, wherein the fold lines correspond to locations of features selected from the group consisting of the top edge of the tray, and an inside corner of the tray.

22. A paint tray liner according to claim 21, further comprising multiple parallel fold lines corresponding to different paint tray sizes.
